(19) United States
(12) Patent Application Publication
(10) Pub. No.: US 2017/0120351 A1
(43) Pub. Date: May 4, 2017

(54) DOUBLE-SIDED CUTTING INSERTS WITH POSITIVE CLEARANCE FACE GEOMETRY

(71) Applicant: Kennametal Inc., Latrobe, PA (US)

(72) Inventors: Xiangdong Daniel Fang, Brentwood, TN (US); Jean-Luc D. Dufour, Franklin, TN (US); Michael R. Cripps, Murfreesboro, TN (US); Kent P. Mizgalski, Stahlstowm, PA (US)

(21) Appl. No.: 14/930,841

(22) Filed: Nov. 3, 2015

(51) Int. Cl. B23C 5/20; B23C 5/06

(52) U.S. Cl. CPC B23C 5/207; B23C 5/06; B23C 5/205; B23C 2200/286; B23C 2200/045

(57) ABSTRACT

A double-sided cutting insert that has a positive clearance face and includes a top portion, a bottom portion substantially identical to the top portion, and a middle portion. The inscribed diameter at the middle portion is larger than the inscribed diameter at each of the top portion and the bottom portion. The double-sided cutting insert having positive clearance face provides a simplified grinding method in order to achieve the dimensional precision required as well as reduced tooling cost allowing both positive and negative double-sided cutting inserts seat in the same insert-receiving pocket on the same tool holder.

### BACKGROUND

Cutting inserts, whether made of carbide (e.g., cemented carbides) and other materials such as, for example, ceramics and cermets, are well known in the art. Many indexable milling cutting inserts are single-handed due to the geometrical constraints in a rotary machining operation where the cutting tool is rotating against a stationary work piece being machined. The great majority of single-sided milling inserts have a positive clearance face below the cutting edges, and thus, are often referred as positive cutting inserts. Most double-sided milling inserts do not have a positive clearance face below the cutting edges, and thus, are often referred as negative cutting inserts. The present disclosure is directed to a double-sided cutting insert with positive clearance face below its cutting edges. A double-sided milling cutting insert doubles the number of available cutting edges for use in the material removal operation as compared with a similar single-sided milling cutting insert.

Cutting inserts comprising a positive clearance face geometry are commonly employed in milling operations involving the use of a rotary tool holder with an indexable capability. In the machining of difficult-to-machine materials like titanium or high temperature alloys, a sufficient positive clearance face is even more critical because the low modulus of elasticity of titanium materials causes greater workpiece spring back resulting in the following undesirable consequences: excessive tool vibration or chatter, undesirable rubbing between the cutting inserts and workpiece, as well as poor surface finish. The positive cutting geometry of the cutting inserts reduces the cutting forces, and consequently, reduces power consumption, resulting in a more efficient rotary milling operation. Typical positive cutting geometry on a cutting insert includes a positive rake angle on the top rake face and one or more positive clearance angles on the tool flank or clearance face below the cutting edge. A positive rake face plus a positive clearance face will provide a sharp cutting edge that would efficiently cut into the materials and significantly reduce the cutting forces, in particular, for difficult-to-machine materials, like titanium.

According to ISO (International Organization for Standardization) standards, a cutting insert for rotary milling applications is normally defined by dimensional features like inscribed diameter on the tool rake face, thickness and nose corner radius, and also by geometrical features like peripheral shape, clearance face angle on the tool flank face, fastener hole configuration. Typically cutting inserts with different diameter of the inscribed diameter (IC) would need different insert pockets, and thus, different tool holders. Further, double-sided cutting inserts with same inscribed diameter, but different clearance face angles, such as a negative cutting insert with a zero or even negative clearance angle verses a positive cutting insert with a similar style, but positive clearance angle, would also need different insert pockets, and thus, different tool holders. This would increase the types of the corresponding tool holders necessary to accommodate cutting inserts with the same inscribed diameter, but different clearance angles. Therefore, there is a need for an improved double-sided cutting insert for a milling cutting tool system where double-sided cutting inserts with the same or close inscribed diameter, but different clearance face angles, can fit into the same insert pocket, and thus use the same single tool holder.

In order to have a better understanding about the differences among an indexable single-sided cutting insert with positive clearance face, an indexable double-sided cutting insert with negative clearance face, and an indexable double-sided cutting insert with positive clearance face, FIGS. 1A THROUGH 1E are constructed to demonstrate some most common shapes of prior art cutting inserts (simplified geometry). Case 1 in FIG. 1A is a most common single-sided cutting insert 1 comprising a top face 1a, a bottom face 1b, a fastener hole 1d, a symmetric axis 1f through the center of the fastener hole 1d, and a peripheral clearance face 1c having a positive clearance angle (or less than 90 degrees if measured from a horizontal reference). Case 2 in FIG. 1B is a common double-sided cutting insert 2 comprising a top face 2a, an identical bottom face 2b with reference to the mid line 2h, a fastener hole 2d, a symmetric axis 2f through the center of the fastener hole 2d, and a peripheral clearance face 2c having a negative clearance angle (or 90 degrees if measured from a horizontal reference). Case 3 in FIG. 1C is a double-sided cutting insert 3 comprising a top face 3a, an identical bottom face 3b with reference to the mid line 3h, a fastener hole 3d, a symmetric axis 3f through the center of the fastener hole 3d, a peripheral clearance face 3c having a negative clearance angle (or more than 90 degrees if measured from a horizontal reference), and a second peripheral face 3e functioning as lateral support surface when secured in an insert pocket on a tool holder. Case 4 in FIG. 1D is a double-sided cutting insert 4 comprising a top face 4a, an identical bottom face 4b with reference to the mid line 4h, a fastener hole 4d, a symmetric axis 4f through the center of the fastener hole 4d, a peripheral clearance face 4c having a positive clearance angle (or less than 90 degrees if measured from a horizontal reference), and a second peripheral face 4e functioning as lateral support surface when secured in an insert pocket on a tool holder. Case 5 in FIG. 1E is a double-sided cutting insert 5 comprising a top face 5a, an identical bottom face 5b with reference to the mid line 5h, a fastener hole 5d, a symmetric axis 5f through the center of the fastener hole 5d, and a peripheral clearance face 5c having a positive clearance angle (or less than 90 degrees if measured from a horizontal reference).

Only a few indexable double-sided cutting inserts with positive clearance face angle have been developed in today's cutting tool industries. Representative examples similar to Cases 4 and 5 in the above FIGS. 1D and 1E, respectively, include U.S. Pat. No. 8,206,066, US Patent Application Publication 2013/0101364, US Patent Application Publication 2013/0195567, and US Patent Application Publication 2014/0030034. The common feature of all the above prior art indexable double-sided cutting inserts with positive clearance face angle is the inscribed diameters (IC) at the top face and the identical bottom face are larger than that at any middle portions between the top and bottom faces, and this creates two disadvantages. First, it is often difficult to fit a double-sided cutting insert having a positive clearance face angle and a corresponding regular double-sided cutting insert having negative clearance face angle into the same pocket. Second, it is complicated and difficult to grind the lateral support surfaces at the middle portion of a double-sided cutting inserts having positive clearance face angle due to the use of the relative very large grinding wheel surface against a much smaller insert having a narrower and recessed lateral support surface (due to a smaller inscribed diameter than those on the top and bottom sides of the cutting insert), which may be demonstrated by the following two prior art examples as shown in FIGS. 2A-2C and FIGS. 3A-3C.

FIGS. 2A, 2B and 2C show a prior art double-sided square cutting insert having positive clearance face, which is similar to Case 4 in FIG. 1D. The double-sided cutting insert 10 in FIGS. 2A, 2B and 2C comprises three portions, a top portion 11, an identical bottom portion 12 and a middle portion 15. The top portion 11 comprises a positive clearance face 11a (A_top>0), a cutting edge 11b, and a top rake face 11c. The identical bottom portion 12, with reference to the mid line 19, comprises a positive clearance face 12a (A_bot=A_top and A_bot>0), a cutting edge 12b, and a bottom rake face 12c. The middle portion 15 comprises a planar peripheral face 15a and a cylindrical peripheral face 15b where the planar peripheral face 15a functioning as a lateral support surface abutting the pocket wall when secured in an insert receiving pocket on a tool holder. The cutting insert has a fastener hole 16 and a symmetric axis 17 through the center of the fastener hole 16. The inscribed diameter IC_top, as shown in FIG. 2C, is the diametric circle 21 inscribed to the cutting edges 11b (totally four indexable cutting edges) at the top portion 11 while the inscribed diameter IC_mid, is the diametric circle 25 inscribed to the planar peripheral face 15a at the mid portion 15. Obviously, IC_top>IC_mid, therefore, it is complicated and difficult to grind the planar peripheral face 15a at the middle portion 15 in consideration of a much larger grinding wheel surface.

FIGS. 3A, 3B and 3C illustrate a prior art double-sided round cutting insert having positive clearance face, which is similar to Case 5 in FIG. 1E. The double-sided cutting insert 30 in FIGS. 3A, 3B and 3C comprises three portions, a top portion 31, an identical bottom portion 32 and a middle portion 35. The top portion 31 comprises a positive clearance face 31a (A_top>0), a cutting edge 31b, and a top rake face 31c. The identical bottom portion 32, with reference to the mid line 39, comprises a positive clearance face 32a (A_bot=A_top), a cutting edge 32b, and a bottom rake face 32c. The middle portion 35 comprises a circular peripheral line or face 35a. The cutting insert has a fastener hole 36 and a symmetric axis 37 through the center of the fastener hole 36. The inscribed diameter IC_top, as shown in FIG. 3C, is the diametric circle 41 inscribed to the cutting edge 31b at the top portion 31 while the inscribed diameter IC_mid is the diametric circle 45 inscribed to the peripheral line or face 35a at the mid center line 39. The cutting insert 30 will not be possible to share the same pocket with a corresponding double-sided cutting insert having a negative clearance face with a cutting insert like Case 2 in FIG. 1B wherein the clearance angle equals zero degrees.

Therefore, it would be desirable to produce an indexable double-sided cutting insert having positive clearance face that only requires a simple straight grinding to achieve a precision lateral support surface and that can allow both positive and negative double-sided cutting inserts to seat in the same insert receiving pocket in the same tool holder.

### SUMMARY

In order to address the foregoing needs, the present disclosure describes embodiments of a double-sided cutting insert having positive clearance face that provides for a simplified grinding method in order to achieve the dimensional precision required as well as reduced tooling cost by allowing both positive and negative double-sided cutting inserts to seat in the same insert-receiving pocket in the same tool holder.

More particularly, embodiments of a double-sided cutting insert having positive clearance face may generally comprise: a top portion, a bottom portion identical to the top portion, and a middle portion where the inscribed diameter is larger than those at the top face and the bottom face, i.e. IC_mid>IC_top, IC_mid>IC_bot and IC_top=IC_bot.

The advantage of IC_mid>IC_top and IC_mid>IC_bot is that this relationship between the inscribed diameters greatly simplifies the grinding operation for an indexable double-sided cutting insert having positive clearance face because a much larger grinding wheel will not touch or damage the cutting edges at both the top and bottom faces. Another advantage of IC_mid>IC_top and IC_mid>IC_bot is that this relationship between the inscribed diameters significantly reduces the tooling cost by allowing both positive and negative double-sided cutting inserts to seat in the same insert receiving pocket in the same tool holder.

These and other advantages will be apparent upon consideration of the following description of certain embodiments in connection with the following drawing figures.

### BRIEF DESCRIPTION OF THE DRAWINGS

Embodiments of the double-sided cutting insert can be best understood by reference to the following drawing figures, wherein:

FIG. 1A illustrates a common shape of a Case 1 prior art cutting insert with a simplified geometer.

FIG. 1B illustrates a common shape of a Case 2 prior art cutting insert with a simplified geometer.

FIG. 1C illustrates a common shape of a Case 3 prior art cutting insert with a simplified geometer.

FIG. 1D illustrates a common shape of a Case 4 prior art cutting insert with a simplified geometer.

FIG. 1E illustrates a common shape of a Case 5 prior art cutting insert with a simplified geometer.

FIGS. 2A (isometric view), 2B (side view) and 2C (top view) show a prior art double-sided square cutting insert having positive clearance face.

FIGS. 3A (isometric view), 3B (side view) and 3C (top view) illustrate a prior art double-sided round cutting insert having positive clearance face.

FIG. 4A is an isometric view of a first specific embodiment of a double-sided hexagon cutting insert having positive clearance faces according to present invention.

FIG. 4B is a cross-sectional view of the cutting insert of FIG. 4A taken along section line G-G in FIG. 4C.

FIG. 4C is a top view of the cutting insert of FIG. 4A.

FIG. 5A is a side view of a cutting tool system that holds a series of cutting inserts similar to that illustrated in FIGS. 4A-4C.

FIG. 5B is an enlarged view of the area of Detail F shown in FIG. 5A.

FIGS. 6A (isometric view), 6B (cross-sectional view) and 6C (top view) illustrate a conventional prior double-sided cutting insert without positive clearance faces.

FIGS. 7A (side view) and 7B (enlarged view detail G) illustrate a cutting tool system comprising a tool holder which is the same as that in FIG. 5A, but holds five conventional double-sided cutting inserts without positive clearance faces.

FIG. 8A is an isometric view of an embodiment of a double-sided round cutting insert having positive clearance faces according to present invention.

FIG. 8B is a cross-sectional view of the embodiment of the cutting insert of FIG. 8A taken along section line B-B of FIG. 8C.

FIG. 8C is a top view of the cutting insert of FIG. 8A.

FIG. 9A is an isometric view of another embodiment of a double-sided round cutting insert having positive clearance faces according to present invention.

FIG. 9B is a cross-sectional view of the cutting insert of FIG. 9A taken along section line C-C of FIG. 9C.

FIG. 9C is a top view of the cutting insert of FIG. 9A.

FIG. 10A is an isometric view of another different embodiment of a double-sided round cutting insert having positive clearance faces according to present invention.

FIG. 10B is a cross-sectional view of the cutting insert of FIG. 10A taken along section line A-A of FIG. 10C.

FIG. 10C is a top view of the cutting insert of FIG. 10A.

FIG. 11A illustrates a cutting tool system comprising a steel body or tool holder that is able to hold four indexable double-sided cutting inserts either with positive clearance faces or without positive clearance faces.

FIG. 11B illustrates a cutting tool system comprising a steel body or tool holder that is able to hold four indexable double-sided cutting inserts either with positive clearance faces or without positive clearance faces.

FIG. 12A is an isometric view of an embodiment of a single-handed double-sided cutting insert having positive clearance faces and having generally square-shaped periphery according to present invention.

FIG. 12B is a cross-sectional view of the cutting insert of FIG. 12A taken along section line J-J of FIG. 12C.

FIG. 12C is a top view of the cutting insert of FIG. 12A.

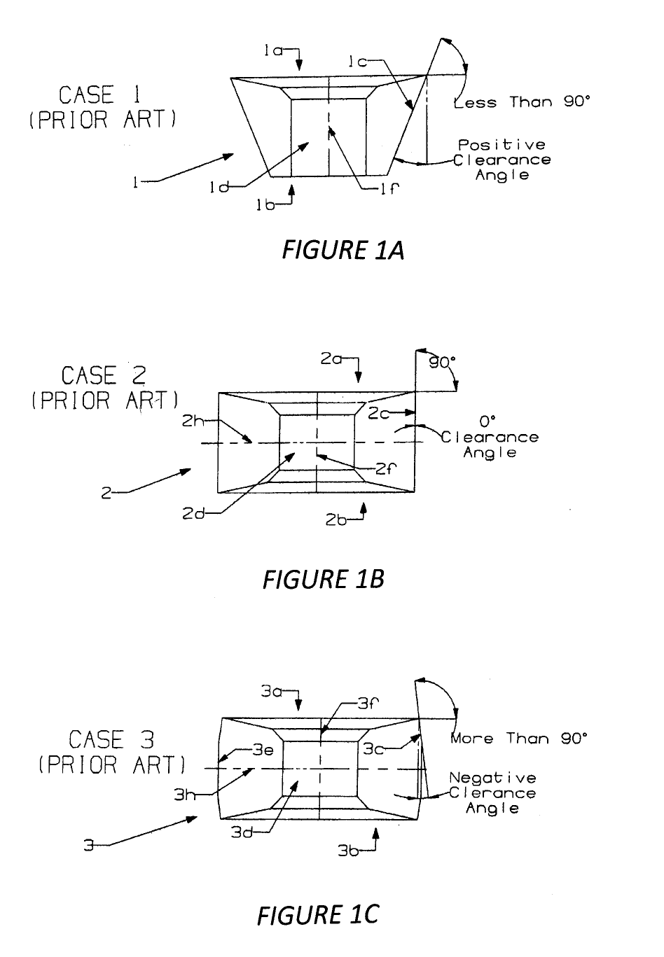

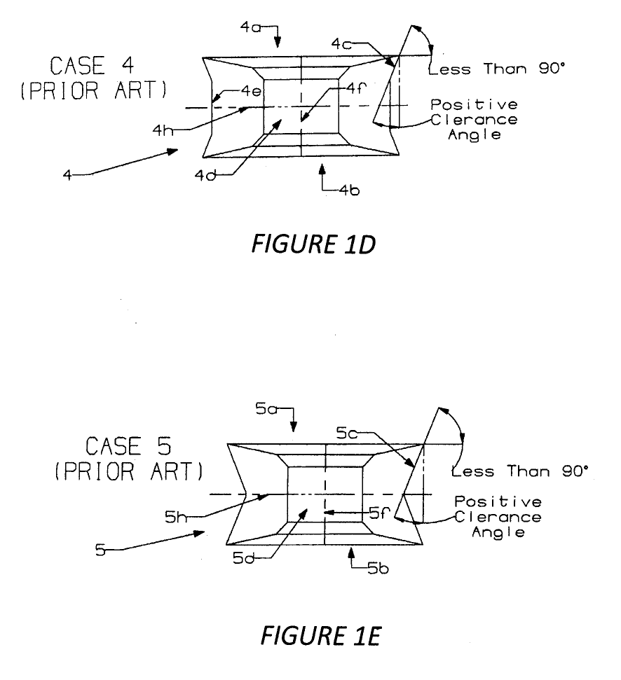

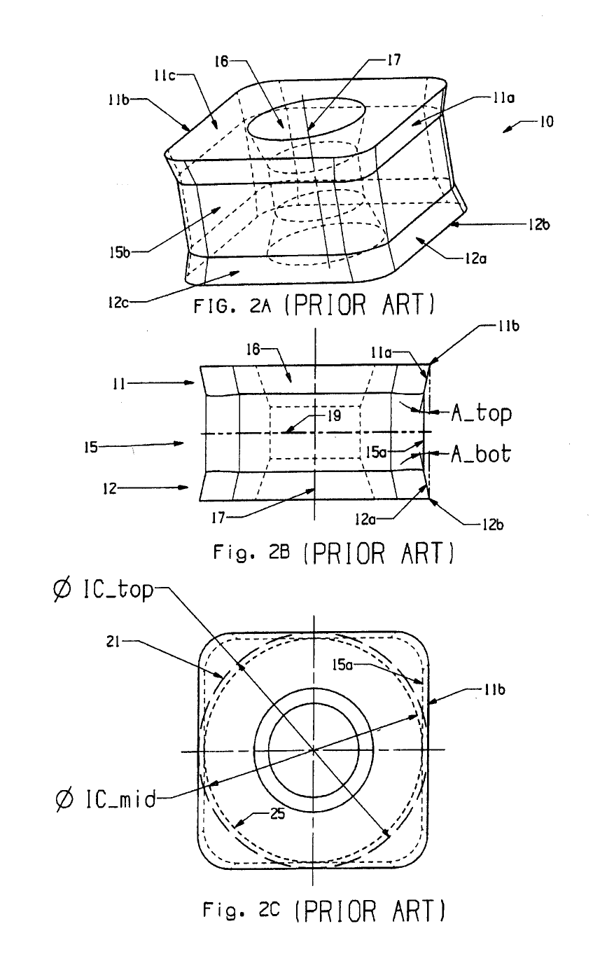

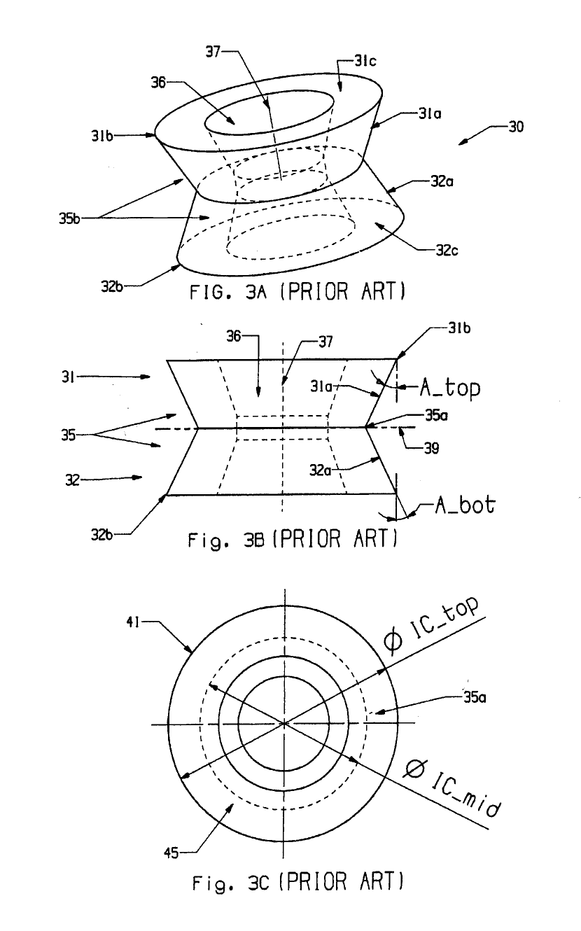

### DETAILED DESCRIPTION

It is to be understood that certain descriptions of the present invention herein have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. For example, as discussed herein, embodiments of the cutting inserts of the present disclosure may be produced in the form of double-sided cutting insert having positive clearance face for metal materials cutting. The methods by which cutting inserts are manufactured are generally understood by those of ordinary skill in the art and, accordingly, are not described in details herein. In addition, all the geometric shapes should be considered to be modified by the term “substantially” wherein the term “substantially” means that the shape is formed within typical design and manufacturing tolerances for a double-sided cutting insert with each side having a positive clearance face.

Furthermore, certain embodiments of the double-sided cutting inserts according to the present disclosure are disclosed in the form of face milling cutting inserts. It will be understood, however, that the double-sided cutting inserts may be embodied in forms, and applied to end uses, that are not specifically and expressly described herein. For example, one skilled in the art will appreciate embodiments of the double-sided cutting inserts having positive clearance faces may be manufactured as cutting inserts for other methods of removing metal from work pieces.

Certain embodiments of the present invention are directed to double-sided cutting inserts, including double-sided single-handed inserts, which provide an increased number of indexable cutting edges. Moreover, a double-sided cutting insert can be configured to provide each side having a positive clearance face, under and around cutting edges, with a conventional size adapted for conventional use in a variety of milling and/or machining applications.

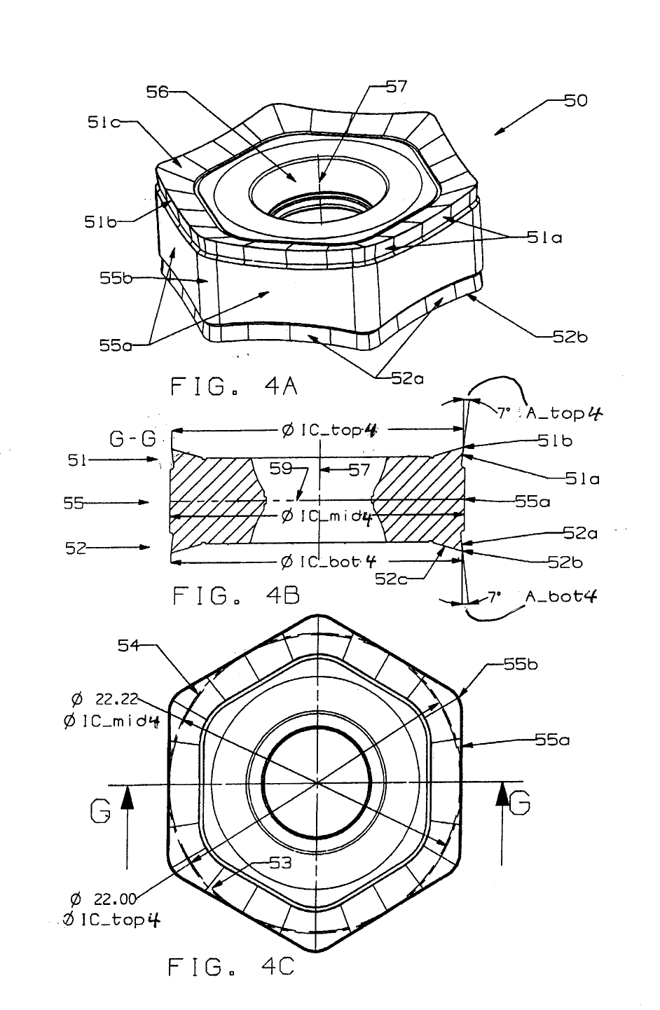

Referring now to FIGS. 4A, 4B and 4C showing the embodiment of a double-sided polygonal (hexagon) cutting insert having positive clearance faces according to present invention. The double-sided cutting insert 50 comprises three portions, a top portion 51, an identical bottom portion 52 and a middle portion 55. The top portion 51 comprises a positive clearance face 51a with a clearance angle designated as A_top4 is greater than zero degrees and equal to 7° (see FIG. 4B), a cutting edge 51b, and a top rake face 51c. The identical bottom portion 52 with reference to the mid line 59 comprises a positive clearance face 52a with a clearance angle designated as A_bot4 and equal to 7° (see FIG. 4B) and wherein clearance angle A_top4 is equal to clearance angle A_bot4 and both clearance angles (A_top4 and A_bot4 are greater than zero degrees. There is a cutting edge 52b, and a bottom rake face 52c. The middle portion 55 has a generally polygonal periphery and comprises a planar peripheral face 55a and a cylindrical peripheral face 55b where the planar peripheral face 55a functions as a lateral support surface abutting the pocket wall when secured in an insert receiving pocket on a tool holder. The cutting insert 50 has a fastener hole 56 and a symmetric axis 57 through the center of the fastener hole 56.

The inscribed diameter IC_top4, as shown in FIG. 4B and FIG. 4C, is the diametric circle 53 inscribed to the cutting edges 51b (totally six indexable cutting edges per side) at the top portion 51, while the inscribed diameter IC_mid4, is the diametric circle 54 inscribed to the planar peripheral face 55a at the mid portion 55. Inscribed diameter IC_mid4 as a dimension equal to 22.22 and inscribed diameter IC_top4 has a dimension equal to 22.00. The ratio IC_mid4/IC_top4 is equal to 22.22/22.00 (or 1.010). Obviously, inscribed diameter IC_top4 is less than the inscribed diameter IC_mid4, therefore, it is simple and easy to grind the middle planar peripheral face 55a to achieve desired dimension precision because the much larger grinding wheel will not touch or damage the cutting edges 51b and 52b. Further, the inscribed diameter IC_bot4 (see FIG. 4B) is of the same dimension (diameter) as the inscribed diameter inscribed diameter IC_top4, and therefore, the diametrical relationship is inscribed diameter IC_bot4 is less than inscribed diameter IC_mid4.

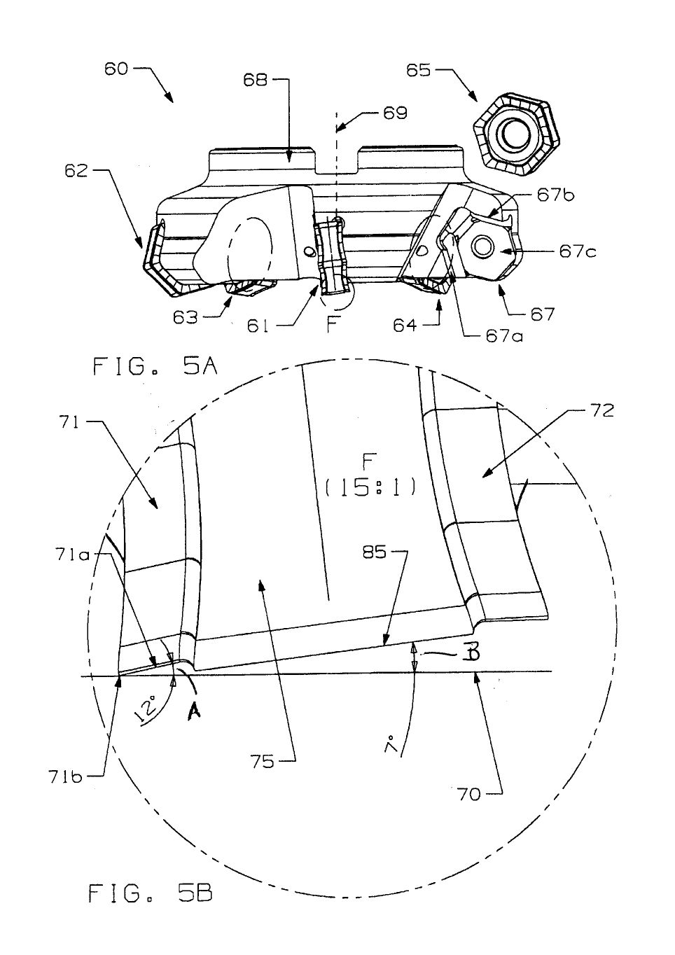

FIG. 5A shows a cutting tool system 60 that holds a series of cutting inserts 61 through 65 wherein these cutting inserts are the same as those cutting inserts 50 illustrated in FIGS. 4A-4C. The cutting tool system 60 comprises a steel body or tool holder 68 and five double-sided polygonal cutting inserts 61-65 each having positive clearance faces and each being positioned evenly around the cutter axis 69. The cutting insert 65 is moved up to show the insert-receiving pocket 67 comprising two pocket support walls 67a and 67b and one seating face 67c. FIG. 5B is a scaled view from Detail F in FIG. 5A demonstrating the working position of a double-sided cutting insert 61 wherein the cutting insert 61 comprises a top portion 71, an identical portion 72 and a middle portion 75. The top portion 71 comprises an active cutting edge 71b and a corresponding clearance face 71a forming a positive clearance angle A and shown as equal to 12° with the workpiece surface 70 while the middle lateral support face 85 forms a clearance angle B and shown as equal to 7° with the workpiece surface 70. FIG. 5B demonstrates an efficient and effective way to increase the positive clearance (from 7° to 12°), while the cutting insert is on a tool holder, by using the unique concept of double-sided cutting inserts with positive clearance faces as presented in this invention, which is particularly useful in machining titanium or high-temperature alloys.

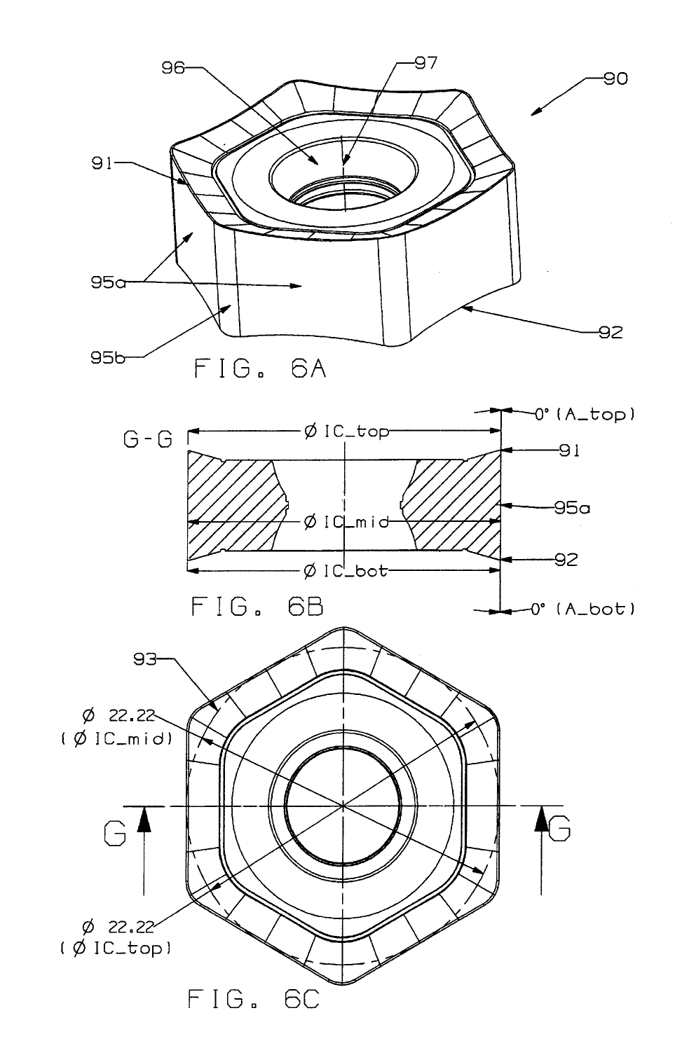

For a comparative purpose, FIGS. 6A-6C show a conventional prior double-sided polygonal cutting insert 90 without positive clearance faces wherein the cutting insert 90 comprises three portions, a top portion 91, an identical bottom portion 92 and a middle portion 95. The middle portion 95 has a generally polygonal periphery and comprises a cylindrical peripheral face 95b and a planar polygonal peripheral face 95a which functions not only as a lateral support face abutting a pocket wall but also as the clearance face for the top cutting edge 91 with a negative clearance angle (A_top=0°) and for the bottom cutting edge 92 with a negative clearance angle (A_bot=0°). The cutting insert 90 has a fastener hole 96 and a symmetric axis 97 through the center of the fastener hole 96. The inscribed diameter IC_top (or inscribed diameter IC_bot) as shown in FIG. 6B and FIG. 6C, is the diametric circle 93 being equal to the inscribed diameter IC_mid.

FIG. 7A demonstrates a cutting tool system 100 comprising a steel body or tool holder 68 which is the same as that in FIG. 5A but holds five conventional double-sided cutting inserts 90a-90e same as the cutting insert 90 described in FIGS. 6A-6C. The cutting insert 90e is moved up to show the insert-receiving pocket 67 comprising the same pocket walls/seating face 67a, 67b and 67c. FIG. 7B is a scaled (enlarged) view from Detail G in FIG. 7A demonstrating the working position of a double-sided cutting insert 90a wherein the cutting insert 90a comprises a top cutting edge 101, an identical bottom cutting edge 102 and a middle lateral support face 105. A clearance angle C shown as being equal to 7° is formed between the lateral support face 105 of the cutting insert 90a (while on a pocket 67 of the tool holder 68) and the workpiece surface 70.

A comparison of FIGS. 5A-5B and FIG. 7A and FIG. 7B demonstrate advantages of using the double-sided cutting inserts with positive clearance faces according to this invention as compared to using a conventional cutting insert. First, the present invention exhibits an increased clearance angle (see angle A in FIG. 5B equal to 12°) for an active cutting edge. Second, the inventive double-sided cutting inserts with positive clearance faces and a corresponding conventional double-sided cutting insert can fit into the same pocket, thus use the same tool holder. Third, it is easy and simple to grind the lateral support or seating faces of the inventive double-sided cutting inserts with positive clearance faces to achieve the desired dimension precision and surface quality.

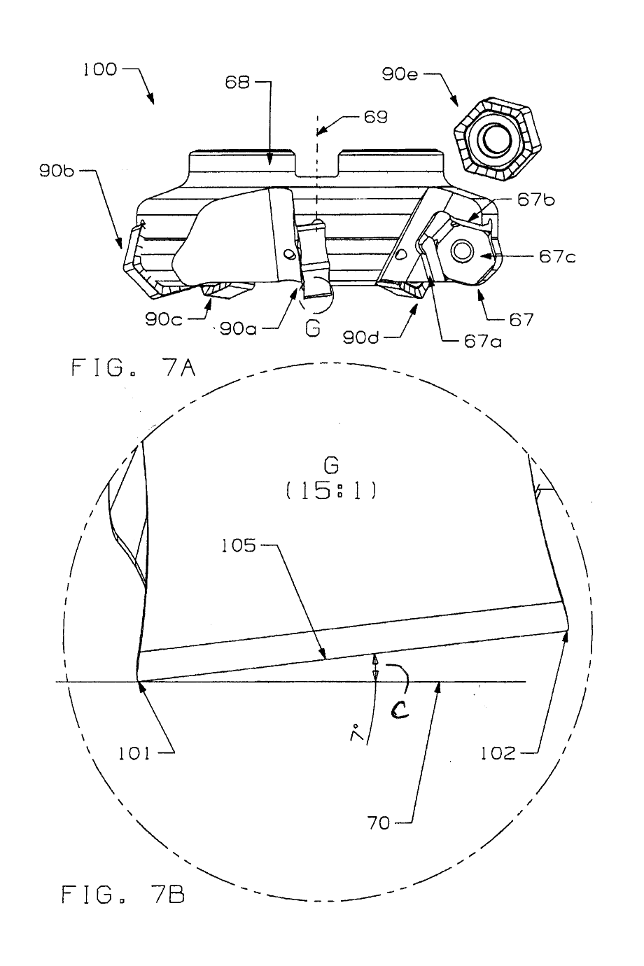

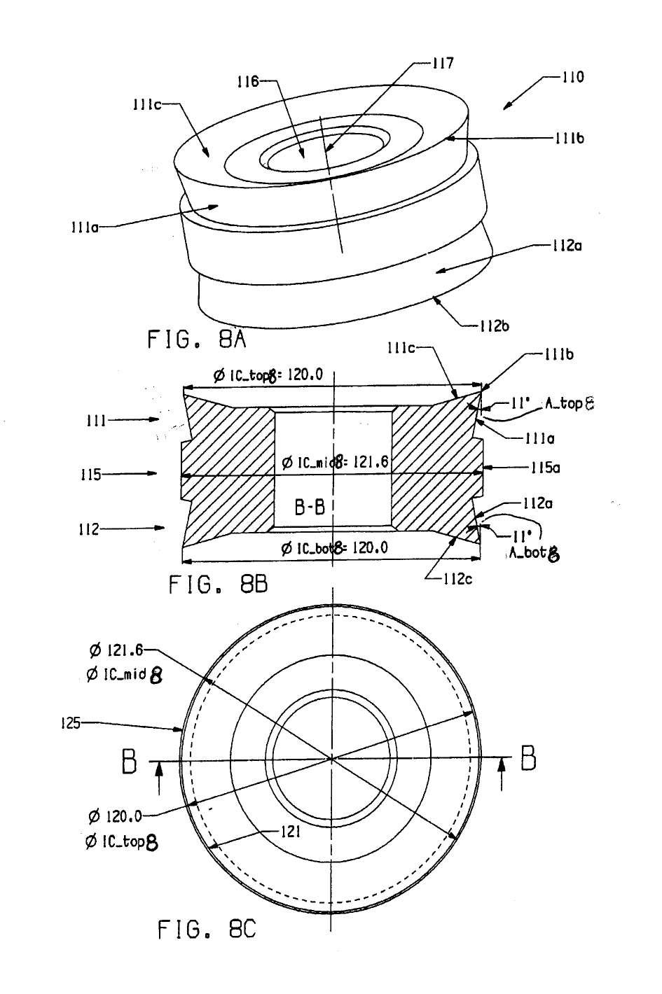

FIGS. 8A, 8B and 8C illustrate an embodiment of a double-sided round cutting insert having positive clearance faces according to present invention. The double-sided cutting insert 110 comprises three portions, a top portion 111, an identical bottom portion 112 and a middle portion 115. The top portion 111 comprises a positive clearance face 111a with a clearance angle designated as A_top8 greater than zero degrees and equal to 11° (see FIG. 8B), a cutting edge 111b, and a top rake face 111c. The identical bottom portion 112, comprises a positive clearance face 112a with a clearance angle designated as A_bot8 and equal to 11° wherein the clearance angle A_bot8 is equal to the clearance angle A_top8 and the clearance angle A_bot8 is greater than zero degrees, a cutting edge 112b, and a bottom rake face 112c. The middle portion 55 comprises a circular peripheral face 115a. The cutting insert 110 has a fastener hole 116 and a symmetric axis 117 through the center of the fastener hole 116. The inscribed diameter IC_top8, as shown in FIG. 8B and FIG. 8C, is the diametric circle 121 (that has a dimension equal to 120.0) inscribed to the cutting edge 111b at the top portion 111 (or inscribed diameter IC_bot8 for the cutting edge 112b at the bottom portion 112), while the inscribed diameter IC_mid8 (that has a dimension equal to 121.6), is the diametric circle 125 inscribed to the round peripheral face 115a at the mid portion 115. The ratio inscribed diameter IC_mid8/inscribed diameter IC_top8 is equal to 121.6/120.0 (or 1.013). Obviously, inscribed diameter IC_top8 is less than the inscribed diameter IC_mid8 and inscribed diameter IC_top8 is equal to inscribed diameter IC_bot8. Therefore, for the same reasons as those described in conjunction with the cutting insert of FIGS. 4A-4C, it is simple and easy to grind the middle round peripheral face 115a to achieve the desired dimensional precision because the much larger grinding wheel will not touch or damage the cutting edges 111b and 112b.

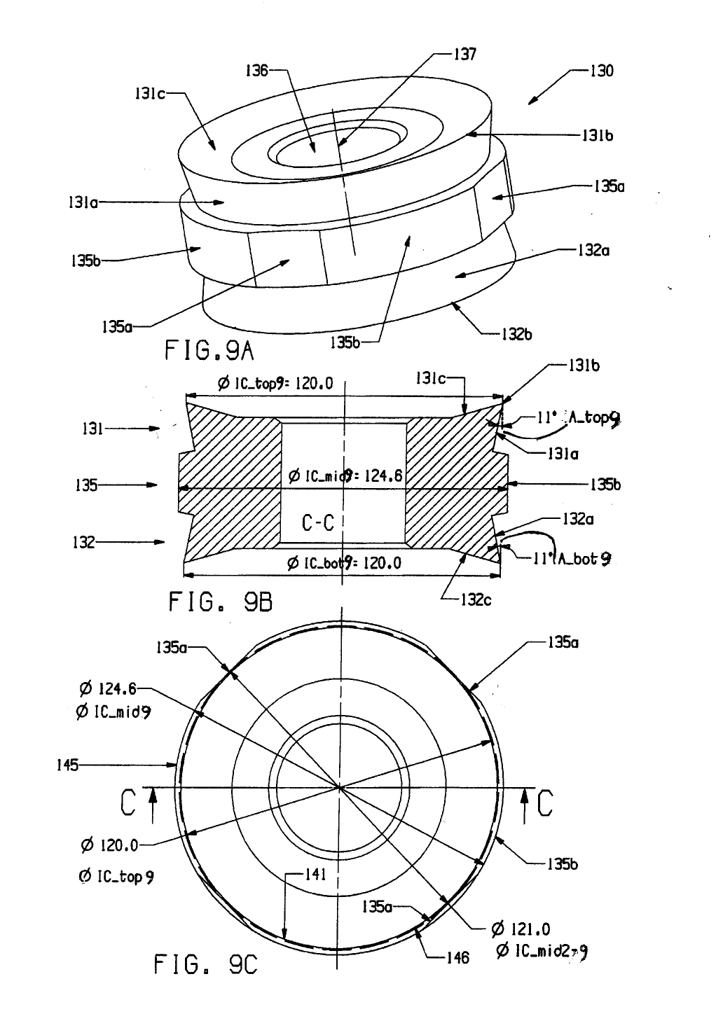

FIGS. 9A, 9B and 9C further demonstrate another embodiment of a double-sided round cutting insert having positive clearance faces according to present invention. The double-sided cutting insert 130 comprises three portions, a top portion 131, an identical bottom portion 132 and a middle portion 135. The top portion 131 comprises a positive clearance face 131a with a clearance angle designated as A_top9 greater than zero degrees and equal to 11° (see FIG. 9B), a cutting edge 131b, and a top rake cutting face 131c. The identical bottom portion 132, comprises a positive clearance face 132a with a clearance angle designated as A_bot9 and equal to 11° (see FIG. 9B) and wherein clearance angle A_bot9 is equal to clearance angle A_top9 and clearance angle A_bot9 is greater than zero degrees, a cutting edge 132b, and a bottom rake face 132c. The middle portion 135 comprises a circular peripheral face 135b truncated by a number of flat faces 135a. The circular face 135b functions as a lateral support face to abut against a pocket wall on a tool holder. Alternatively, the truncated flat surface 135a may be used as a lateral support face to abut against a pocket wall, and additionally performing an anti-rotation mechanism. The cutting insert 130 has a fastener hole 136 and a symmetric axis 137 through the center of the fastener hole 136. The inscribed diameter IC_top9 (that has a dimension equal to 120.0), as shown in FIG. 9B and FIG. 9C, is the diametric circle 141 inscribed to the cutting edge 131b at the top portion 131 (or IC_bot9 for the cutting edge 132b at the bottom portion 132), while the inscribed diameter IC_mid9 (that has a dimension equal to 124.6), is the diametric circle 145 inscribed to the round peripheral face 135b at the mid portion 135. As shown in the drawings, inscribed diameter IC_mid9 is greater than inscribed diameter IC_top9 and inscribed diameter IC_top9 is equal to inscribed diameter IC_bot9. The ratio inscribed diameter IC_mid9/inscribed diameter IC_top9 is equal to 124.6/120.0 (or 1.038). Alternatively if the truncated flat surface 135a is used as a lateral support surface, the inscribed diameter IC_mid2-9 (that has a dimension equal to 121.0 and is larger than IC_top9), is the diametric circle 146 inscribed to all the truncated flat surfaces 135a at the mid portion 135.

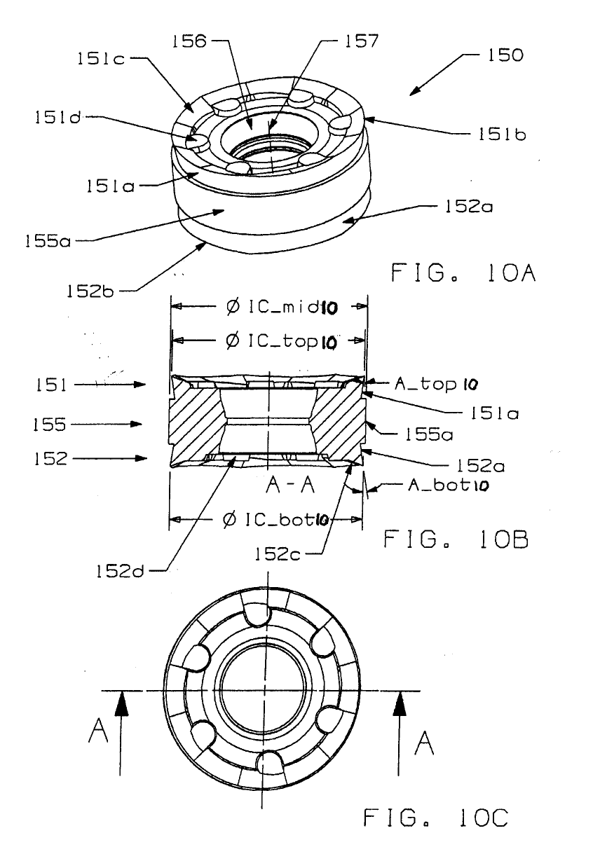

FIGS. 10A, 10B and 10C further illustrate another different embodiment of a double-sided round cutting insert having positive clearance faces according to present invention. The double-sided cutting insert 150 comprises three portions, a top portion 151, an identical bottom portion 152 and a middle portion 155. The top portion 151 comprises a positive clearance face 151a with a clearance angle designated as A_top10 is greater than zero degrees, a cutting edge 151b, a top rake cutting face 151c and a series of projected extrusions 151d on each side of the cutting insert 150. The identical bottom portion 152, comprises a positive clearance face 152a with a clearance angle designated as A_bot10 wherein the clearance angle A_bot10 is equal to clearance angle A_top10 and clearance angle A_bot10 is greater than zero degrees, a cutting edge 152b, a bottom rake face 152c and a series of projected extrusions 152d (invisible in FIG. 10A). The middle portion 155 comprises a circular peripheral face 155a. Each projected extrusion 151d will abut against a recess on pocket seat face on a tool holder thus performing an anti-rotation mechanism. The cutting insert 150 has a fastener hole 156 and a symmetric axis 157 through the center of the fastener hole 156. The inscribed diameter IC_top10 at top portion 151 (or IC_bot10 at the bottom portion 152), as shown in FIG. 10B, is smaller than IC_mid10 at the middle portion 155.

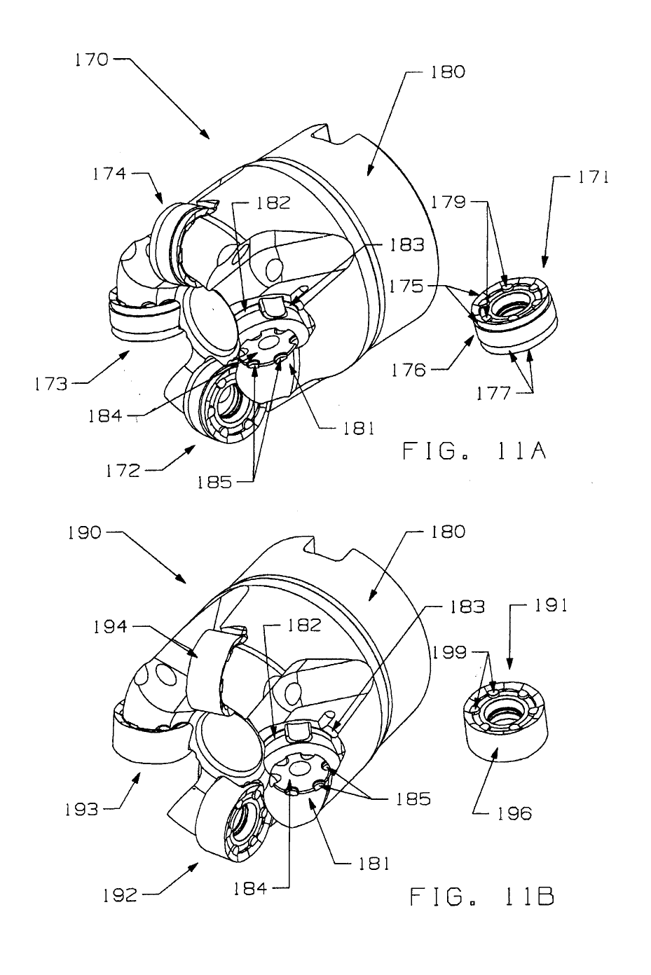

FIG. 11A presents a cutting tool system 170 comprising a steel body or tool holder 180 for holding four indexable double-sided round cutting inserts 171-174 which are basically the same as the cutting insert 150 as described in FIGS. 10A-10C. The cutting insert 171 as shown in FIG. 11A has a top portion 175, an identical bottom portion 177, a middle portion 176, and a series of projected extrusions 179 on the top rake face of the top portion 175. Furthermore the cutting insert 171 is moved up to expose the insert-receiving pocket 181 comprising a first pocket wall 182, a second pocket wall 183, a seating face 184 and a series of recesses 185 on the seating face 184.

FIG. 11B shows a cutting tool system 190 comprising an exactly same tool holder 180 and same pocket 181 as that in FIG. 11A but holds four conventional double-sided round cutting inserts 191-194 each having a circular peripheral surface 196 and a series of projected extrusions on both sides of the double-sided cutting insert 191. FIG. 11A/FIG. 10 and FIG. 11B demonstrate that two different styles of cutting inserts 150/171 (inventive) and 191 (conventional) but having same inscribed diameter on the circular peripheral faces 155a/176 and 196, as an example, can fit into the same pocket, thus the same tool holder, which would greatly reduce the tooling cost for both cutting tool end users and cutting tool manufacturers.

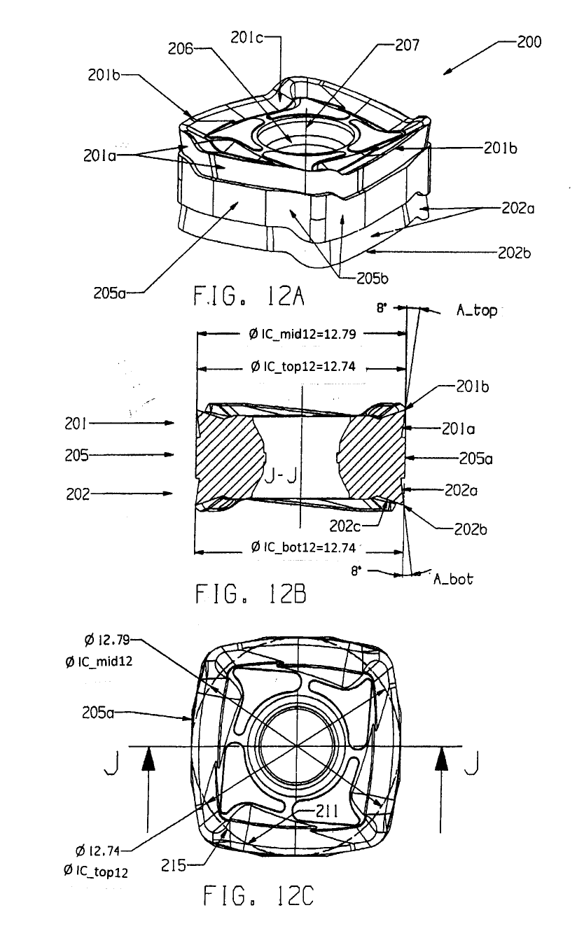

FIGS. 12A, 12B and 12C present an embodiment of a double-sided cutting insert having positive clearance faces according to present invention. The double-sided cutting insert 200 is a single-handed cutting insert and has a generally square-shaped profile with each side comprising four indexable convex cutting edges for the machining applications involving high feed milling. The cutting insert 200 comprises three portions, a top portion 201, an identical bottom portion 202 and a middle portion 205. The top portion 201 comprises a positive clearance face 201a with a clearance angle designated as A_top12 and equal to 8° (see FIG. 12B) wherein the clearance angle A_top12 is greater than zero degrees, a convex cutting edge 201b, a top rake cutting face 201c. The identical bottom portion 202, comprises a positive clearance face 202a with a clearance angle designated as A_bot12 and equal to 8° (see FIG. 12B) wherein the clearance angle A_bot12 is equal to the clearance angle A_top and the clearance angle A_bot12 is greater than zero degrees, a convex cutting edge 202b, a bottom rake face 202c (see FIG. 12B). The middle portion 205 comprises a lateral planar surface 205a and convex peripheral face 205b. The cutting insert 200 has a fastener hole 206 and a symmetric axis 207 through the center of the fastener hole 206. Each of the inscribed diameter IC_top12 (diametric circle 211 that has a dimension equal to 12.74) at top portion 201 (or inscribed diameter IC_bot12 at the bottom portion 202), as shown in FIG. 12B and FIG. 12C, is smaller than inscribed diameter IC_mid12 (diametric circle 215 that has a dimension equal to 12.79) being tangent to the planar surface 205a at the middle portion 205. The ratio IC_mid12/IC_top12 is equal to 12.79/12.74 (or 1.003).

Accordingly, certain non-limiting embodiments of the double-sided cutting inserts with positive clearance surfaces are described herein. The double-sided cutting inserts may be of known sizes and shapes, and may be adapted for conventional use in a variety of milling applications. It will be understood that the present description may illustrate only those aspects of the invention relevant to providing a clear understanding thereof, and that certain aspects would be apparent to those of ordinary skill in the art. Therefore, such aspects as would not be necessary to facilitate a better understanding of the invention may not be present in order to simplify the description.

Furthermore, although only a limited number of embodiments of the invention are necessarily described herein, one of ordinary skill in the art will, upon considering the foregoing description, recognize that many modifications and variations of the invention may be employed. All such variations and modifications of the invention are intended to be covered by the foregoing description and the following claims.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. A double-sided cutting insert having positive clearance faces comprising a top portion, a substantially identical bottom portion and a middle portion between the top portion and bottom portion; the top portion having an inscribed diameter, the bottom portion having an inscribed diameter, and the middle portion having an inscribed diameter; and the inscribed diameter of the top portion being less than the inscribed diameter of the middle portion, the inscribed diameter of the bottom portion being less than the inscribed diameter of the middle portion, and the inscribed diameter of the top portion being approximately equal to the inscribed diameter of the bottom portion.

2. The double-sided cutting insert having positive clearance faces of claim 1 wherein the middle portion has a general polygonal peripheral face comprising at least a lateral planar support surface.

3. The double-sided cutting insert having positive clearance faces of claim 1 wherein the middle portion has a circular peripheral face truncated by at least a lateral planar support surface.

4. The double-sided cutting insert having positive clearance faces of claim 1 wherein the middle portion comprises a circular peripheral face.

5. The double-sided cutting insert having positive clearance faces of claim 1 wherein the top portion has a top face with chip breaker geometry and the bottom portion has a bottom face with chip breaker geometry.

6. The double-sided cutting insert having positive clearance faces of claim 1 wherein each of said top portion and the bottom portion is single-handed in a same direction.

7. The double-sided cutting insert of claim 1 wherein a ratio of the inscribed diameter of the middle portion to the inscribed diameter of the top portion ranges between about 1.003 and about 1.038.

8. A milling tool system comprising:
a tool holder;
a number of double-sided cutting inserts having positive clearance faces wherein each double-sided cutting insert having positive clearance faces comprises a top portion, a substantially identical bottom portion and a middle portion between the top portion and bottom portion; the top portion having an inscribed diameter, the bottom portion having an inscribed diameter, and the middle portion having an inscribed diameter; and the inscribed diameter of the top portion being less than the inscribed diameter of the middle portion, and the inscribed diameter of the bottom portion being less than the inscribed diameter of the middle portion, and the inscribed diameter of the top portion being approximately equal to the inscribed diameter of the bottom portion.

9. The milling tool system of claim 8 wherein the double-sided cutting insert having positive clearance faces wherein the middle portion has a generally polygonal peripheral face comprising at least a lateral planar support surface.

10. The milling tool system of claim 8 wherein the double-sided cutting insert having positive clearance faces wherein the middle portion has a circular peripheral face truncated by at least a lateral planar support surface.

11. The milling tool system of claim 8 wherein the double-sided cutting insert having positive clearance faces wherein the middle portion comprises a circular peripheral face.

12. The milling tool system of claim 8 wherein the double-sided cutting insert having positive clearance faces wherein the top portion has a top face with chip breaker geometry and the bottom portion has a bottom face with chip breaker geometry.

13. The milling tool system of claim 8 wherein the double-sided cutting insert having positive clearance faces wherein each of said top portion and the bottom portion is single-handed in a same direction.

14. A milling tool system comprising:
a tool holder comprising at least an insert-receiving pocket comprising two pocket walls and a pocket seating face); and
wherein the same pocket receives and holds either a double-sided cutting insert with positive clearance faces or a conventional double-sided cutting insert lacking positive clearance faces; and
wherein the double-sided cutting insert with positive clearance faces comprising a top portion, a substantially identical bottom portion and a middle portion between the top portion and bottom portion; and
wherein the top portion having an inscribed diameter, the bottom portion having an inscribed diameter, and the middle portion having an inscribed diameter; and
wherein the inscribed diameter of the top portion being less than the inscribed diameter of the middle portion, the inscribed diameter of the bottom portion being less than the inscribed diameter of the middle portion; and the inscribed diameter of the top portion being approximately equal to the inscribed diameter of the bottom portion.

15. A milling tool system of claim 14 wherein the tool holder is a tool holder for holding double-sided round cutting inserts and wherein the double-sided cutting insert with positive clearance faces is a double-sided round cutting insert with positive clearance faces; and
wherein the tool holder comprises at least an insert-receiving pocket comprising two pocket walls and a pocket seating face; and
wherein the same pocket receives and holds either the double-sided round cutting insert having positive clearance faces and having a circular peripheral face or the conventional double-sided round cutting insert lacking positive clearance faces and having a circular peripheral face; and
wherein the inscribed diameter of the circular peripheral face of the middle portion of the double-sided round cutting insert with positive clearance faces is equal to that of the inscribed diameter of the circular peripheral face of the conventional double-sided round cutting insert.

16. A milling tool system of claim 14 wherein the tool holder is for holding the double-sided cutting insert with positive clearance faces and having a generally polygonal peripheral face; and
wherein the tool holder comprises at least an insert-receiving pocket comprising two pocket walls and a pocket seating face; and
wherein the same pocket receives and holds either the double-sided cutting insert having positive clearance faces having the generally polygonal peripheral face or a conventional double-sided polygonal cutting insert lacking positive clearance faces and having a polygonal peripheral face; and
wherein the inscribed diameter of the middle portion of the double-sided cutting insert having positive clearance faces is equal to the inscribed diameter of the polygonal peripheral face of the conventional double-sided polygonal cutting insert.
